(19) United States
(12) Patent Application Publication
(10) Pub. No.: US 2012/0282499 A1
(43) Pub. Date: Nov. 8, 2012

(54) ELECTROCHEMICAL CELL

(75) Inventors: Guenter Eichinger, Altenstadt (DE); Tim Schaefer, Niedersachswerfen (DE)

(73) Assignee: LI-TEC BATTERY GMBH, Kamenz (DE)

(21) Appl. No.: 13/500,350

(22) PCT Filed: Aug. 17, 2010
(86) PCT No.: PCT/EP10/05043

§ 371 Date: Jul. 25, 2012

(30) Foreign Application Priority Data
Oct. 5, 2009 (DE) 10 2009 048 236.9

(51) Int. Cl. H01M 2/12

(52) U.S. Cl. 429/56

(57) ABSTRACT

An electrochemical cell has an electrode stack, which is sealed off by a sheath, in particular in a gas-tight and/or liquid-tight manner, and at least one pressure-relief device, in particular in the form of a desired breaking point, wherein the pressure-relief device has a rupture diaphragm, which closes an aperture in the sheath.

### CROSS-REFERENCE TO RELATED APPLICATIONS

This application is a National Phase application under 35 U.S.C. §371 of International Application No. PCT/EP2010/005043, filed Aug. 17, 2010 and published as WO 2011/042092 on Apr. 14, 2011, which claims priority to German patent application serial number DE 10 2009 048 236.9, filed Oct. 5, 2009, the entirety of each of which is hereby incorporated herein by reference.

### FIELD OF THE INVENTION

The present invention relates to an electrochemical cell and a battery arrangement having at least one such electrochemical cell.

### BACKGROUND

A flat pack lithium-ion battery with a rupture area on the housing frame thereof is known from German patent DE 10 2007 063 193 A1. On that product, an overpressure relief valve is incorporated in an opening. The overpressure relief valve comprises a safety membrane that ruptures in critical overpressure situations to enable gases to escape.

The object of the present invention is to provide an improved electrochemical cell. This object is solved with an electrochemical cell having features described herein. Advantageous embodiments of the invention are described herein.

### SUMMARY

According to the invention, an electrochemical cell is provided having an electrode stack that is sealed off by a sheath, in particular in a gas-tight and/or liquid-tight manner, and at least one pressure relief device particularly in the form of a desired breaking point, wherein the at least one pressure relief device has a rupture diaphragm which closes off a perforation of the sheath.

For the purposes of the invention, the term sheath is understood to mean an at least partial limitation that separates the electrode stack or stacks from the outside. The sheath is preferably gas- and liquid impermeable, so that materials cannot be exchanged with the surrounding medium. The electrode stacks are arranged inside the sheath. The sheath includes at least one sheath section, particularly a plurality of sheath sections. For example, one sheath section may be made from a molded part. Two molded parts may be used. In addition, sheath section may be represented by a frame or even a frame part. At least one current collector, particularly two current collectors, protrude from the sheath and serve as connectors for the electrode stack. The protruding current collectors then preferably constitute the positive terminal connection and the negative terminal connection of the electrochemical cell. However, multiple current collectors, particularly four current collectors, may also protrude from sheath. In this case, if the electrochemical cell includes two electrode stacks that are connected to one another in series, two electrodes of different electrode stacks are connected to one another.

For the purposes of the invention, an electrode stack is understood to mean a device that as a component of an electrochemical or galvanic cell also serves to store chemical energy and deliver electrical energy. For this purpose, the electrode stack includes several plate-like elements, at least two electrodes (anode and cathode) and a separator that accommodates the electrolyte at least in part. Preferably, at least one anode, one separator and one cathode are placed or stacked one on top of the other, the separator being at least partly disposed between the anode and the cathode. This sequence of anode, separator and cathode may be repeated any number of times within the electrode stack. The plate-like elements are preferably wound up to form an electrode coil. In the following, the term “electrode stack” will also be used to refer to electrode coils. Stored chemical energy is converted into electrical energy before it is delivered as such. During charging, the electrical energy that is supplied to the electrode stack or galvanic cell is converted into chemical energy and stored as such. The electrode stack preferably includes multiple electrode pairs and separators. It is particularly preferred if some electrodes are connected to each other, and particularly that the connection is electrical.

For the purposes of the present invention, the term frame is intended to mean any structural device that is designed to stabilize the cell mechanically against environmental influences, particularly against forces that are exerted from the outside or the inside and that may be connected permanently with the packaging of the cell. As the choice of term suggests, a frame is preferably an essentially frame-like structure whose function is essentially to lend mechanical stability to a galvanic cell. The frame may constitute a part of the sheath.

Under certain conditions, particularly overloading, short circuit or overheating, excess pressure may build up in electrochemical cells. In extreme cases, such excess pressure may cause the sheath to rupture and/or may result in a fire. In this event, neighboring electrochemical cells may also be affected. The provision of a pressure-relief device can help to alleviate the consequences of the conditions described in the preceding. Such a pressure-relief device is particularly a device that, when a given pressure is created, that is to say a rupturing pressure, particularly enables material to escape from the interior of the electrochemical cell. A pressure-relief device may also enable material to escape to the outside from the electrochemical cell when a given temperature, particularly a rupturing temperature, is reached or exceeded. To this extent, a pressure-relief device may also trigger a pressure relief process solely when the rupturing temperature occurs, regardless of the pressure.

A pressure-relief process takes place in particular when material from the electrochemical interior of the cell is able to escape to the outside particularly due to the opening of the pressure-relief device. In this context, the pressure-relief device is constructed in the form of a predetermined rupture point. A predetermined rupture point is particularly designed such that parts of the pressure-relief device are destroyed in the event of a pressure relief process.

According to the invention, the pressure-relief device has a rupture diaphragm that closes an aperture in the sheath. In this context, the rupture diaphragm only closes the aperture in the sheath if a pressure relief process is not in progress. In the case of an actual pressure relief process, the closure of the aperture by the rupture diaphragm is destroyed so that the rupture diaphragm is at least partially unable to prevent material from passing through the aperture. More precise configurations of the rupture diaphragm and the corresponding capabilities of the rupture diaphragm to close the aperture will be explained in greater detail in the following.

The rupture diaphragm may be made from a plastic, particularly a polymer. The geometrical dimensions and/or mechanical properties of the rupture diaphragm may be designed such that it loses its mechanical stability when the rupture pressure or the rupture temperature is reached and is thus no longer able to keep the sheath closed off. The plastic for manufacturing the rupture diaphragm may be selected from the group consisting of PE, PP, PTFE, CTFE, FEP, HFP, or other, particularly fluorinated polymers.

The rupture diaphragm is preferably made from a foil. The foil may be at least partly destroyed, particularly torn, when the rupture pressure is reached or exceeded. The foil may also melt when the rupture temperature is reached or exceeded.

The rupture diaphragm and the sheath are preferably made from essentially identical material. Then, the sheath may initially be produced fully closed, and the rupture diaphragm may be separated out of the sheath subsequently, particularly by cutting or stamping. The rupture disk may then be fixed firmly to the sheath permanently again. In this way, the costs of producing the sheath together with the pressure-relief device may be reduced.

The rupture diaphragm preferably includes several layers, particularly including a layer for reducing diffusion. A diffusion-reducing layer may preferably be based on fluorinated polymers, silicon, or kerosene. One layer of the rupture diaphragm may also be made from a metal, particularly aluminium. One layer may be vapor deposited on another layer of the rupture diaphragm, in particular the aluminium layer may be vapor deposited on the plastic layer. Hydrocarbon-based plastics in particular promote the diffusion of water and water vapor. The diffusion reducing layer then preferably prevents the diffusion of water and water vapor through the rupture diaphragm. This may also be achieved with a metal layer. These configurations also apply generally for sheath parts. To ensure that one of the two layers is only able to exert negligible mechanical influence on the rupturing properties of the rupture diaphragm, that layer may be perforated.

A metal layer of the sheath, particularly of a part of the sheath and/or of the rupture diaphragm, may be coated with a polymer film. This may prevent possible corrosion of the metal layer. Particularly if the metal layer is facing towards the interior of the electrochemical cell, this may prevent corrosion by the electrode stack and the materials included therein. The metal layer may be pretreated by targeted oxidation to form a dense oxide layer, particularly by anodizing. This too may provide further resistance to corrosion. Additionally, a metal layer may also undergo further pretreatments, which particularly have an anticorrosion effect. These particularly include the application of a metal oxide layer, a metal nitrite layer or other protective layers, particularly by plasma methods, sputtering, or electrolytic treatments.

The pressure-relief device preferably triggers a pressure relief process when a rupture temperature is reached. One layer of the rupture diaphragm may be made from a substance having a melting temperature below the rupture temperature. In this way, it may be possible to ensure that the layer whose melting temperature is lower than the rupture temperature melts, thus in particular losing its mechanical properties before the rupture temperature is reached. Since this layer only possesses negligible mechanical properties by the time the rupture temperature is reached, the exact adjustment of the rupture point may only be set on the other layer. In this context, the term rupture point is used to mean the operating state in which a pressure relief process is triggered by the pressure-relief device. The rupture point is defined in particular by the rupture temperature and/or the rupture pressure.

The rupture diaphragm is preferably constructed from a layer of polymer and a layer of kerosene, wherein the melting point of the kerosene layer is below 85° C., and particularly at about 80° C., and the polymer layer has a melting point preferably higher than 95° C., particularly at about 100° C.

The aperture may be circular in shape. The circular shape may be produced particularly easily by drilling. Alternatively, the aperture may have an angular shape. Particularly if the aperture is located on a narrow side of the sheath, it is advantageous if the aperture has an elongated shape, that is to say the aperture has an extension in a first direction of its cross section that is several times longer, particularly at least twice as long, as the extension thereof in a second extension perpendicular to the first.

The rupture diaphragm is preferably configured to be larger than the aperture. In this way, it is possible to ensure that the rupture diaphragm covers the aperture fully and thus particularly rests on a shoulder on the sheath. In this way, a better sealing effect may be achieved.

The rupture diaphragm is preferably attached to the sheath by sealing or adhesion. In this way, the rupture diaphragm may be bonded with the sheath in material locking manner. The manner of sealing or adhesion itself may thus determine the rupture temperature or rupture pressure. If the sealing or adhesion dimension is increased, the rupture pressure or rupture temperature may be increased. Conversely, if the sealing or adhesion dimension is reduced, the rupture pressure or rupture temperature may be lowered.

In an alternative embodiment, the rupture diaphragm is screwed into the aperture. For this, the aperture is preferably furnished with a thread that is formed in the aperture. Alternatively, the thread may be made when the rupture diaphragm is screwed in. For this purpose, the rupture diaphragm may particularly be furnished with a self-cutting thread. The rupture diaphragm is preferably provided with means that enable torque to be transferred to the rupture diaphragm. Particularly for this purpose, known shapes from screw heads may be used. These may particularly be a hexagonal shape or allen key shape.

The rupture diaphragm may also be retained in over the aperture via a retaining element. In particular, the retaining element may be of separate construction. The retaining element may be fastened to a section of the sheath in material locking and/or non-positive locking and/or positive locking manner. The retaining element may secure the rupture diaphragm over the aperture in material locking and/or non-positive locking and/or positive locking manner. Alternatively, the retaining element may be screwed onto a thread in the aperture. In this context, the rupture foil may be arranged between the retaining element and a shoulder in the aperture. When the retaining element is screwed against the shoulder, the rupture foil is clamped and thus held fast between the retaining element and the shoulder. In an embodiment in which a shoulder is not necessarily provided, the retaining element may be screwed onto a thread inside the aperture. Then, the foil is positioned over the thread in the aperture and when the retaining element is screwed on the foil is held fast between the threads of the retaining element and the aperture.

The rupture diaphragm preferably has an area larger than a cross section of the aperture.

Preferably, a separate sealing means is provided between the rupture diaphragm and the sheath. This may particularly by a polymer seal. The sealing means may preferably be conformed in the form of a disc or ring.

The electrochemical cell preferably has a cutting means, particularly a spike or blade, which may damage parts of the sheath, particularly the rupture diaphragm. In particular, the cutting means may pierce parts of the sheath. By damaging the sheath, the mechanical stability of the sheath may be reduced, particularly in the area of the pressure-relief device, which may have effects on the rupture pressure or rupture temperature. When parts of the sheath are pierced by the cutting means, a pressure relief process is triggered thereby, because material is able to escape to the outside from the interior of the electrochemical cell at the site where the sheath is pierced. The cutting means may be placed against the aperture for the outside. Thus, the cutting means may penetrate into the aperture. The cutting mains may be attached to a plate or disc that is placed onto the aperture from the outside. The plate or disc may be constructed so as to be permeable for gases and/or liquids.

The cutting means is preferably arranged outside the rupture diaphragm and directed toward the rupture diaphragm. Its arrangement outside means in particular that the cutting means is arranged on a side of the sheath and the rupture diaphragm that is facing away from the interior of the electrochemical cell. In other words, the rupture diaphragm is particularly arranged between the interior of the electrochemical cell and the cutting means. The rupture pressure may be adjusted using the distance between the cutting means and the rupture diaphragm.

The electrochemical cell is advantageously furnished with sensing means that are able to detect a pressure relief process. With sensing means of such kind, it is possible in particular to communicate to a control unit that the electrochemical cell is in state in which it is no longer functioning properly during and/or after a pressure relief process. The electrochemical cell may be decoupled from other functions immediately, particularly from charging or discharging processes. Such sensing means may be designed as temperature sensors and/or pressure sensors. A necessary pressure relief process may be detected in particular if an initially rising pressure or temperature is detected by means of a pressure or temperature sensor. The gradient of the pressure or temperature change may also be used for this purpose. If the pressure and/or temperature inside the electrochemical cell falls after the rupture pressure and/or rupture temperature is reached or exceeded, this may serve as an indication that a pressure relief process is in progress. Such detection may be made by observing the pressure value alone, or the temperature value alone. In addition, detection may also be assured by observing the pressure and temperature together.

The at least one pressure-relief device is advantageously arranged in an area facing away from a current collector of the electrochemical cell.

The at least one pressure-relief device is also advantageously arranged in area of the electrochemical cell on the side and/or bottom when the electrochemical cell is installed.

According to the latter two advantageous embodiments of the invention, the at least one current collector of the electrochemical call protrudes from the sheath in a first area thereof and the at least one pressure-relief device is arranged in a second area of the sheath facing away from the first area and/or the at least one pressure-relief device is arranged in an area of the electrochemical cell that is on the bottom when the electrochemical cell is installed. In other words, the at least one pressure-relief device is located at the greatest possible distance from the current collectors and/or in the bottom area of the cell.

With particular regard to lithium-ion batteries in the vehicle manufacturing industry, the fact that a battery management system and/or other electronic components are also accommodated in the vicinity of the current collectors for the cells and that the battery is frequently installed underneath a passenger compartment or below a passenger seat in the vehicle presents a series of difficulties. At the same time, it must be borne in mind that the cells are usually installed in the battery housing, and the battery is mounted in the vehicle, in such a way that the current collectors protrude from the cell sheath in a top area of the cell.

In this context, the described advantageous embodiments of the electrochemical cell offer the advantages that when the pressure inside the cell is elevated the pressure relief and the escape of material through the at least one pressure-relief device do not take place in the area of the current collectors and the battery management system, nor in the direction of the passenger compartment. In this way, the operational reliability of the battery and the safety of the passengers may both be increased in the event that a critical pressure state occurs inside and electrochemical cell.

The invention also relates to a battery arrangement comprising at least one, particularly several electrochemical cells of the type described in the preceding.

Other advantages, features and application possibilities of the present invention will be evident from the following description in conjunction with the drawing.

### BRIEF DESCRIPTION OF THE DRAWINGS

FIG. 1 is a diagrammatic representation of an electrochemical cell according to the invention.

FIG. 2 is a cross section through the sheath of the electrochemical cell of FIG. 1.

FIG. 3 is a cross section through an alternative embodiment the sheath of an electrochemical cell 1.

FIG. 4 is a cutaway section through an alternative embodiment the sheath of an electrochemical cell.

FIG. 5 shows various cross section shapes for the apertures.

FIG. 6 shows pressure and temperature curves.

### DETAILED DESCRIPTION

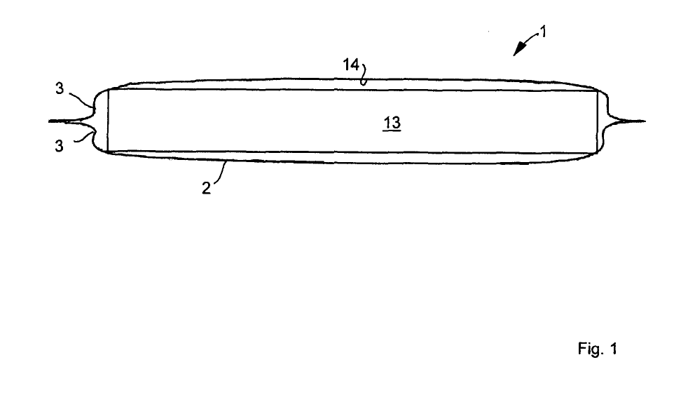

FIG. 1 shows an electrochemical cell 1 according to the invention. In the normal operating state, sheath 2 provides a gas- and liquid-impermeable barrier between interior chamber 14 of electrochemical cell 1 and the surrounding medium. An electrode stack 13 is arranged inside interior chamber 14 of electrochemical cell 1. Multiple electrochemical cells may be arranged in a battery (unit).

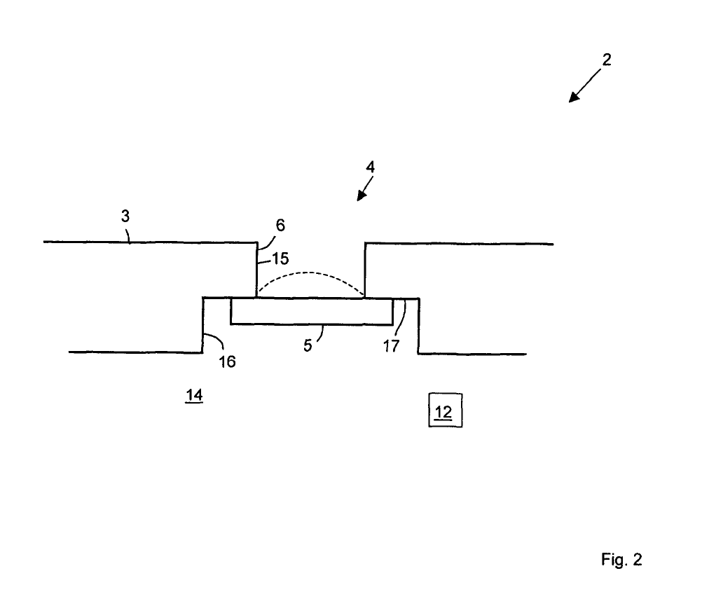

FIG. 2 shows a cross section through sheath 2. This shows that sheath 2 is constructed in multiple sections. At the same time, sheath 2 includes at least one sheath element 3. Sheath element 3 is constructed as a molded part. In the present embodiment, sheath 2 includes two such molded parts 3. However, a sheath element may also have a different form. In particular, a frame may also constitute a sheath element 3. In the present case, the two molded parts 3 make up the largest part of sheath 2.

Sheath element 3 includes an aperture 6 that is closed by a rupture diaphragm 5. Rupture diaphragm 5 and sheath elements 3 together constitute sheath 2.

Rupture diaphragm 5 and aperture 6 together constitute the essential elements of a pressure-relief device 4. In this context, rupture diaphragm 5 is attached to sheath 3 by adhesion. Alternatively rupture diaphragm 5 may be sealed to sheath element 3.

Aperture 6 is of stepped construction and has an outer section 15 and an inner section 16. Outer section 15 has a smaller diameter than inner section 16. A shoulder 17, on which rupture diaphragm 5 rests, is formed inside aperture 6. Rupture diaphragm 5 is placed on shoulder 17 from the inside. Rupture diaphragm 5 fixed on shoulder 17 by adhesion. Rupture diaphragm 5 is produced from a monolayer plastic foil. As internal pressure P rises inside inner chamber 14 of electrochemical cell 1, rupture diaphragm 5 bulges outwards, as is indicated by the dashed line. By the time the rupture pressure is reached, rupture diaphragm 5 is bulged and distended to such a point that it tears. This breaks the seal in sheath 2, so that material is able to escape from inner chamber 14 of electrochemical cell 1 to the outside. At the same time, internal pressure P is able to be relieved. A temperature T inside inner chamber 14 may also be lowered.

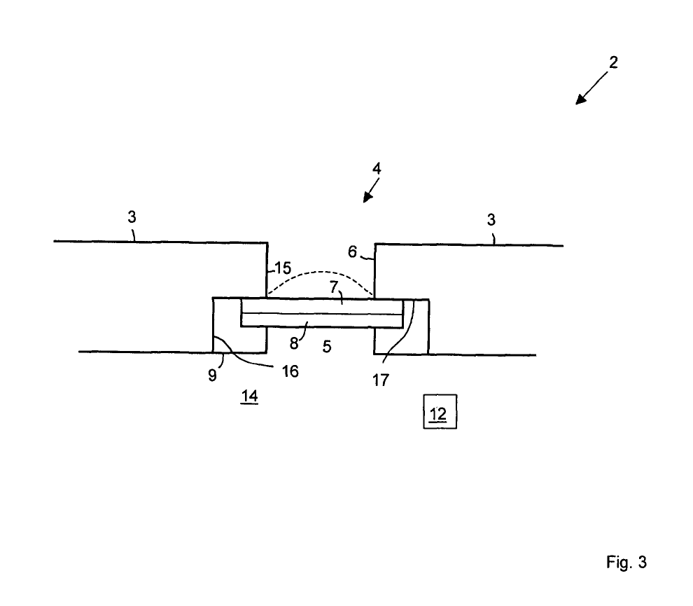

FIG. 3 shows a cross section through an alternative embodiment of the sheath of an electrochemical cell 1, which is largely similar to the sheath of FIG. 2. In this respect, the following text will only describe the differences with regard to FIG. 2. Rupture diaphragm 5 is constructed as a multilayer rupture foil. In this case rupture diaphragm 5 has a first layer 7 and a second layer 8. First layer 7 is made from a polymer. Second layer 8 is made from aluminium. Aluminium layer 8 is more impermeable to water vapour than the polymer layer and in this respect it is designed to reduce diffusion. Aluminium layer 8 also has greater tear resistance. Sheath element 3, which is a molded part, is also constructed from a multilayer material, an outer layer thereof being made from aluminium and an inner layer being made from a polymer. The two layers of rupture diaphragm 5 and the two layers of molded element 3 are interchangeable.

The aluminium layer may also be replaced respectively with a layer based on a fluorinated polymer, silicone or kerosene.

In an alternative embodiment, second layer 8, which constitutes the inner layer of rupture diaphragm 5, may be produced from a kerosene-based material. The kerosene-based material melts at about 80° C. However, the rupture temperature is set at 100° C. Therefore, the second layer has melted and accordingly has no mechanical strength before the rupture temperature is reached. The advantage of this is that only first layer 7 may be considered when dimensioning pressure-relief device 4. Second layer 8 does not change the rupture properties of pressure-relief device 4, particularly not with respect to the rupture temperature.

Rupture diaphragm 5 is placed on shoulder 17. Rupture diaphragm 5 is not affixed directly to shoulder 17 by adhesion or other material locking means. An annular retaining element 9 is provided that is positioned on rupture diaphragm 5 from the inside. Retaining element 9 is fixed permanently in aperture 6, particularly in second section 16 of aperture 6. In order to affix retaining element 9 permanently in aperture 6, retaining element 9 may be inserted in sheath element 3 with interference fitting. Alternatively, retaining element 9 may be affixed in aperture 6 in material locking manner, particularly by adhesion. Alternatively retaining element 9 may be furnished with an external thread that is screwed onto an internal thread in aperture 6. The rupture diaphragm may particularly be designed as a rupture foil and be screwed between the internal thread of aperture 6 and the external thread of retaining element 9.

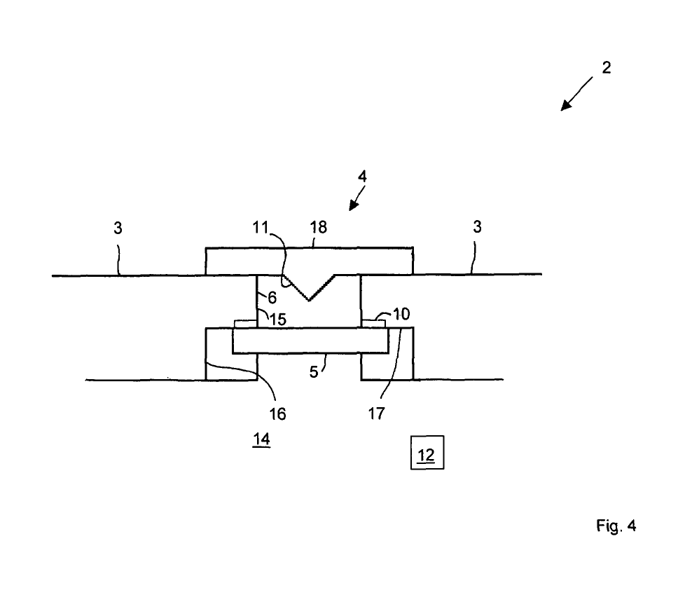

FIG. 4 shows a cross section through another alternative embodiment of the sheath of an electrochemical cell 1, which is largely similar to the sheath of FIG. 3. In this respect, the following text will only describe the differences with regard to FIG. 3, and monolayer rupture foils according to FIG. 1 may also be used. A separate sealing diaphragm 10 is provided between rupture diaphragm 5 and shoulder 17, and this improves the sealing effect in normal operation.

In addition and independently of the previously cited feature, a disc 18 having a centrally disposed spike 11 on an inner surface thereof is positioned thereon. Spike 11 is directed towards rupture diaphragm 5. If the pressure increases, as was described with reference to FIG. 1, rupture diaphragm 5 bulges towards spike 11. When a rupture pressure P_{B} is reached, rupture diaphragm 5 comes into contact with spike 11 and is damaged by spike as a result of the interior pressure, causing sheath 2 to lose its impermeability. To ensure that material is able to escape to the outside from inner chamber 14, the disc 18 that supports the spike is not joined to sheath 2 in sealing manner. Disc 18 may include perforations that allow material to pass through disc 18.

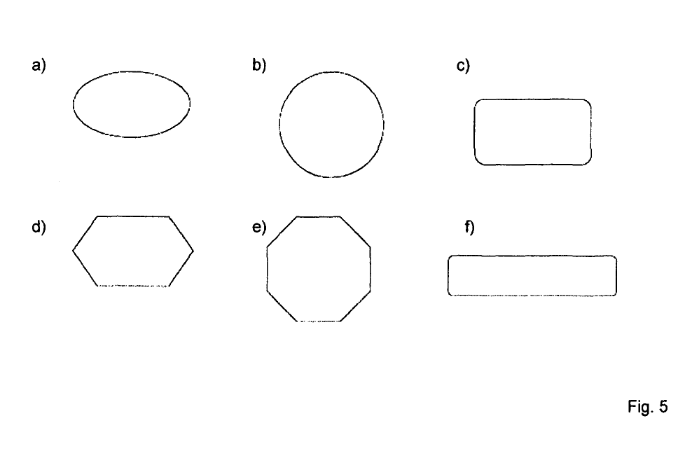

FIG. 5 shows various cross sectional shapes that apertures 6 may have. FIG. 5a) shows an oval shape. FIG. 5b) shows a circular shape. FIG. 5c) shows a rectangular shape with rounded corners. FIG. 5d) shows a regular polygon, in this case a hexagon, wherein the internal angles of the regular polygon are all identical. Only two opposite sides of the regular polygon are configured longer than the other sides. FIG. 5e) shows the shape of a regular octagon. FIG. 5f) is similar to the cross section of FIG. 5c). However, the ratio of the long sides to the short sides is greater than in the cross section of FIG. 5c).

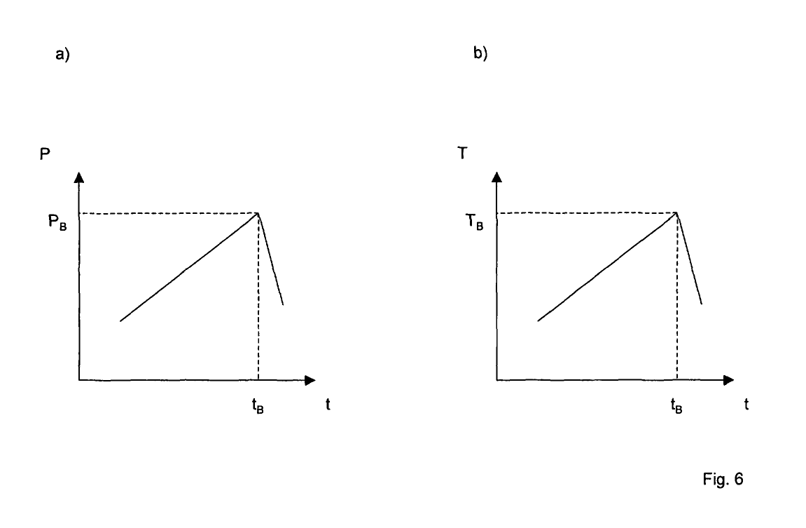

FIG. 6a) shows the pressure curve in internal chamber 14 of electrochemical cell 1. Pressure-relief device 4 is closed during the period t<t_{B}, and consequently a pressure relief process is not in progress. No material can pass through sheath 2 to the outside from inner chamber 14. As time t increases, pressure P rises inside inner chamber 14. At the time of rupture t_{B}, pressure P reaches rupture pressure P_{B}. At this point in time, the pressure-relief device opens and material is able to escape to the outside from inner chamber 14. As a result, pressure P in inner chamber 14 is able to fall, so that in the subsequent time period t>t_{B} pressure P drops again.

FIG. 6b) shows the temperature curve in inner chamber 14 of electrochemical cell 1. The pressure-relief device is closed during the period t<t_{B}. As time t increases, temperature T rises inside inner chamber 14. At the time of rupture t_{B}, temperature T reaches rupture temperature T_{B}. At this point in time, the pressure-relief device opens and material is able to escape to the outside from inner chamber 14. This enables pressure P in inner chamber 14 to fall, so that the temperature in the inner chamber may also be lowered.

A pressure relief process may be detected on the basis of the trend of the pressure curve and/or the trend of the temperature curve via a sensor 12 that is arranged in the inner chamber of the electrochemical cell. A central control unit that is connected to sensing means 12 then isolates the electrochemical cell from further charging or discharging operations.

Although this is not represented explicitly in the figures, the at least one pressure-relief device 4 is preferably provided in an area at the bottom or on the side of sheath 2 of cell 1 facing away from the current collectors of the electrochemical cell, so that the at least one pressure-relief device 4 is arranged at the greatest possible distance from the current collectors and in the bottom and/or side area of cell 1.

In this way, it may be ensured that when the pressure or the temperature inside inner chamber 14 of cell 1 is elevated the pressure relief and the escape of material in a pressure relief process through the at least one pressure-relief device 4 does not take place in the area of the current collectors and the battery management system, nor in the direction of a passenger compartment of an automotive vehicle for example. In this way, the operational reliability of the battery and the safety of the passengers may both be increased in the event that a critical pressure or temperature state occurs in inner chamber 14 of electrochemical cell 1.

1-17. (canceled)

18. An electrochemical cell, comprising:
an electrode stack that is sealed off by a sheath in a gas-tight and liquid-tight manner; and
at least one pressure-relief device particularly in the form of a desired breaking point, the at least one pressure-relief device comprising a rupture diaphragm which closes an aperture in the sheath, wherein the rupture diaphragm comprises multiple layers, of which one is a diffusion-reducing layer.

19. The electrochemical cell as recited in claim 18, wherein a polymer seal in the shape of a disc or ring is provided as a separate sealing means between the rupture diaphragm and the sheath.

20. The electrochemical cell as recited in claim 18, wherein the rupture diaphragm is made from a plastic.

21. The electrochemical cell as recited in claim 18, wherein the rupture diaphragm is made from a foil.

22. The electrochemical cell as recited in claim 18, wherein the rupture diaphragm and the sheath are made from essentially identical material.

23. The electrochemical cell as recited in claim 18, wherein the pressure-relief device is configured such that a pressure relief process is initiated when a rupture temperature is reached, wherein at least one layer of the rupture diaphragm is made from a substance having a melting temperature that is lower than the rupture temperature.

24. The electrochemical cell as recited in claim 18, wherein the rupture diaphragm is coated with kerosene.

25. The electrochemical cell as recited in claim 18, wherein the rupture diaphragm includes at least one layer made from metal applied to the rupture diaphragm.

26. The electrochemical cell as recited in claim 18, wherein the aperture of the sheath has a circular or angular shape.

27. The electrochemical cell as recited in claim 18, wherein the rupture diaphragm is at least one of (a) affixed to the aperture by sealing or adhesion, (b) screwed into the aperture, (c) fastened to the aperture via a retaining element.

28. The electrochemical cell as recited in claim 18, wherein the rupture diaphragm has an area that is larger than the aperture in the sheath.

29. The electrochemical cell as recited in claim 18, further comprising at least one cutting means configured to damage parts of the sheath.

30. The electrochemical cell as recited in claim 18, further comprising sensing means designed so as to be able to detect a necessary pressure relief process.

31. The electrochemical cell as recited in claim 18, wherein the at least one pressure-relief device is arranged in an area facing away from a current collector of the electrochemical cell.

32. The electrochemical cell as recited in claim 18, wherein the at least one pressure-relief device is arranged in an area of the electrochemical cell that is on the bottom and/or side of the electrochemical cell when the electrochemical cell is installed.

33. A battery arrangement comprising at least one electrochemical cell as recited in claim 18.
